(19) United States
(12) Patent Application Publication
(10) Pub. No.: US 2013/0019720 A1
(43) Pub. Date: Jan. 24, 2013

(54) RING PLIERS

(71) Applicants: Barry Harrison, Davisburg, MI (US); Ronald Fred Johnson, Metamora, MI (US); G. Scott Kreft, Chesterfield Township, MI (US); Graig Adamski, Troy, MI (US)

(72) Inventors: Barry Harrison, Davisburg, MI (US); Ronald Fred Johnson, Metamora, MI (US); G. Scott Kreft, Chesterfield Township, MI (US); Graig Adamski, Troy, MI (US)

(21) Appl. No.: 13/522,857

(22) PCT Filed: Jan. 19, 2011
(86) PCT No.: PCT/US11/21649

§ 371 Date: Oct. 15, 2012

Related U.S. Application Data
(60) Provisional application No. 61/296,025, filed on Jan. 19, 2010.
(60) Provisional application No. 61/348,142, filed on May 25, 2010.
(60) Provisional application No. 61/382,291, filed on Sep. 13, 2010.

(51) Int. Cl. B25B 7/10; B25B 27/20

(52) U.S. Cl. 81/409.5; 81/409

(57) ABSTRACT

A ring pliers can be adjusted to work with internal rings and external rings.

### CLAIM OF PRIORITY

This application claims priority to provisional U.S. Patent Application No. 61/296,025, filed Jan. 19, 2010, to provisional U.S. Patent Application No. 61/348,142, filed May 25, 2010, and to provisional U.S. Patent Application No. 61/382,291, filed Sep. 13, 2010, each of which is incorporated by reference in its entirety.

### TECHNICAL FIELD

This invention relates to ring pliers and methods of using ring pliers.

### BACKGROUND

Snap rings can be either “internal” or “external.” The internal type of snap ring can be used to retain elements such as bearings or shafts, within a bore. In order to install the ring, it typically is contracted to allow it to pass into the bore, and then allowed to expand for engagement with an internal groove formed around the bore. The external type of snap ring can be used to retain elements such as bearings, gears or pulleys on shafts. An external ring normally engages an annular groove formed in a shaft to inhibit axial movement of an element mounted on the shaft. An external ring is generally installed by expanding the ring until its internal diameter is greater than the shaft diameter.

### SUMMARY

In one aspect, a ring pliers can include a first lever, which can include a tip configured to engage a ring, an arm extending away from the tip, and a pivot region, the pivot region can include a track including a first lock position and a second lock position, a second lever, which can include a tip configured to engage a ring, an arm, and a pivot region, the pivot region can include an opening, and a locking pin. The locking pin can include a sliding region that can have a dimension for sliding the locking pin along the track from the first lock position to the second lock position. The locking pin can also include a catching region which can pivotally attach the pivot region of the first lever to the pivot region of the second region.

In another aspect, a method of adjusting a ring pliers can include releasing a catching region of a locking pin from a first lock position in a pivot region of a first lever by sliding the locking pin through the pivot region of the first lever until a sliding region of the locking pin is engaged in the pivot region of the first lever, adjusting the sliding region of the locking pin from the first lock position of the pivot region of the first lever to a second lock position of the pivot region of the first lever, and securing the catching region of the locking pin in the second lock position.

In certain circumstances, the locking pin can include a button configured to move the catching region away from and the sliding region into the pivot region of the first lever. Each of the catching region and the sliding region can include a first end and a second end opposite the first end, and the button can be connected to the first end of the sliding region, the second end of the sliding region can be connected to the first end of the catching region, and the second end of the catching region can be connected to a base of the locking pin. Each of the catching region and the sliding region can include a first end and a second end opposite the first end, and the button can be connected to the first end of the catching region, the second end of the catching region can be connected to the first end of the sliding region, and the second end of the sliding region can be connected to a base of the locking pin. The catching region can be a wide pin element and the sliding region can be a narrow pin element. The pliers can also include a compression spring biased to hold the catching region in the pivot region when the button is not depressed. The catching region can include a threaded surface that can engage a complementary threaded surface of the pivot region of the first lever or the second lever. The catching region can include an at least one tenon that engages an at least one mortise in the first or second lock positions in the pivot region of the first lever. The tip of the first lever can extend substantially collinearly with the arms of the lever. The tip of the second lever can extend substantially collinearly with the arms of the lever. At least one arm can include a non-slip handle. The pliers can include a compression spring between the first and second levers.

In some embodiments, the first lock position and the second lock position can be locking apertures.

In another aspect, a method of adjusting a ring pliers can include removing a locking pin from a first locking aperture in a pivot region of a first lever, sliding a locking pin through a track to a second locking aperture in a pivot region of a second lever, and securing the locking pin in the second locking aperture.

In another aspect, a method of using a ring pliers can include positioning a locking pin in a locking aperture of a pliers, engaging a ring with the tips of the first and second levers such that the ring applies a first force to the tips of the first and second levers; applying a second force to the handles of the first and second levers, wherein application of the first force and the second force are applied in the same direction and wherein application of the first force and the second force secure the locking pin in a locking aperture.

Other embodiments are within the claims.

### BRIEF DESCRIPTION OF THE DRAWINGS

FIG. 1 is a perspective view of a ring pliers.

FIG. 2a is perspective view of a first lever.

FIG. 2b is a perspective view of a second lever.

FIG. 3 illustrates a perspective view of a locking pin in a first configuration.

FIG. 4 includes perspective views of a pliers.

FIG. 5 is perspective view of a ring pliers in an external position.

FIG. 6 is a perspective view of a ring pliers in an internal position.

FIG. 7 illustrates the relative position of a first lever when a pliers are in internal and external positions.

FIG. 8 illustrates a pliers in an external position.

FIG. 9 illustrates a pliers in an internal position while in transition.

FIG. 10a illustrates a perspective view of a locking pin in a second configuration.

FIG. 10b illustrates a perspective view of a locking pin in a third configuration.

FIG. 11a is a side view of a ring pliers with the locking pin in a first configuration, further illustrating tips collinear with the arms of the pliers.

FIG. 11b is a side view of a ring pliers with a locking pin in a second configuration, further illustrating angled tips.

FIG. 12a is a cross-section of a locking pin.

FIG. 12b is a side view of a ring pliers with a locking pin in a second configuration, further illustrating tips collinear with arms of a pliers.

FIG. 13a illustrates a cross-section of a first lever pivot region.

FIG. 13b is perspective view of a ring pliers.

FIG. 14a is a perspective view of a pliers.

FIG. 14b is a perspective view of a pliers.

FIG. 15 is a view of a pliers while in transition.

FIG. 16 is a perspective view of a pliers.

FIG. 17 is a perspective view of a pliers in an external position.

FIG. 18 is a perspective view of a pliers in an external position.

FIG. 19 is a perspective view of a pliers in an internal position.

FIG. 20 is a perspective view of a pivot region including locking apertures.

FIG. 21 is a perspective view of a pivot region including locking apertures.

FIG. 22 is a perspective view of a pivot region including locking apertures.

### DETAILED DESCRIPTION

Snap rings, also referred to as retaining rings, circlips, split rings, or compression rings, can be configured as either internal or external rings. The tools typically used for installing and removing internal and external snap rings are different. A tool for installing and removing external rings, for example, must expand the ring to increase its internal diameter in order to accommodate the shaft. An internal ring installation and removal tool, however, must contract the ring in order to decrease its external diameter to enable the ring to pass through a bore. Since the function and performance required of such tools is so substantially different, snap ring pliers are often supplied as single purpose “internal” and “external” tools. These single purpose pliers are intended for use in installing or removing only one type of snap ring. Therefore, both types of pliers are required in order to install or remove both external and internal types of snap rings.

Universal ring pliers, which can be capable of switching between internal and external position, can be preferred because they eliminate the need for multiple tools. Various universal ring pliers are described, for example, in U.S. Pat. No. 6,792,837, U.S. Pat. No. 6,378,403, U.S. Pat. No. 6,145,417, U.S. Pat. No. 5,174,177, U.S. Pat. No. 5,065,650, U.S. Pat. No. 5,007,313, U.S. Pat. No. 4,862,572, U.S. Pat. No. 4,790,056, U.S. Pat. No. 4,625,379, U.S. Pat. No. 4,621,401, and U.S. Pat. No. 4,607,548, each of which is incorporated by reference in its entirety. For example, one set of pliers can include a pair of pivotally interconnected handles and a pair of jaws coupled to the handles by a latching mechanism. The latching mechanism can consist of two latch members capable of sliding transversely. In one position, the latch members can be positioned to allow one handle to be coupled to the first jaw and the other handle to be coupled to the second jaw. Upon transversely sliding the latch members to a second position, the one handle can be coupled to the second jaw and the other handle can be coupled to the first jaw. While this construction has proven successful, it can be relatively complex and it can contain numerous parts that must be properly assembled and aligned during operation to provide proper functioning.

Additional mechanisms exist for switching the pliers from an internal position to an external position, such as a cam mechanism, a twisting locking mechanism or moving pivot pins. Some of the models can require manipulation of interconnected pieces, movement of a linkage arrangement mounted on the tool or disassembly of jaw and/or handle sections in order to accomplish the conversion. This manipulation can be cumbersome. Consequently, a ring pliers that can allow simple switching between the internal and external positions advantageously can be used more readily by a broader spectrum of users in a broader set of circumstances.

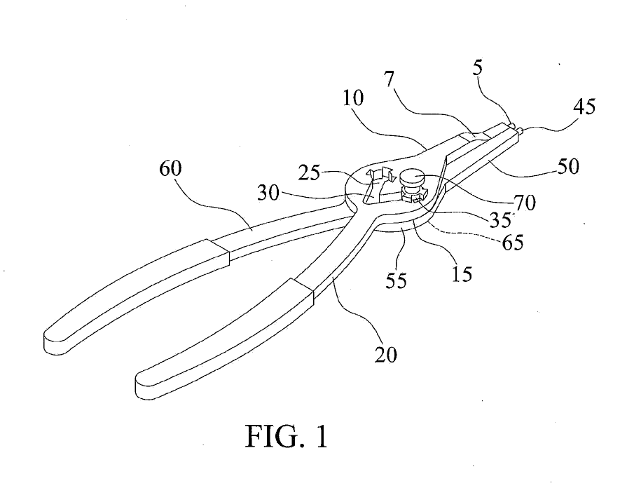

Referring to FIG. 1, the ring pliers can include two levers 20 and 60. Each lever 20, 60 can include a tip 5, 45, an arm 10, 50, and a pivot region 15, 55. Because lever 20 can be positioned above lever 60, tip 5 can be located above tip 45. A bend 7 can be introduced between arm 10 and tip 5 in order to position tip 5 in the same plane as tip 45. The first lever 20 can include a first lock position 25, a track 30 and a second lock position 35 in its pivot region 15. The second lever 60 can include an opening 65 in its pivot region 55. The first 20 and second 60 levers can be pivotally connected to each other by a locking pin 70. The locking pin 70 can pass through the opening 65 in the pivot region 55 in the second lever 60 and into either the first lock position 25, the track 30, or the second lock position 35 in the pivot region 15 of the first lever 20.

Whether the pliers are in an internal or external position can be determined by the location of the locking pin 70. When the locking pin 70 is located in the first lock position 25, the ring pliers can be in the external position. The pliers can transition between the external and internal position by moving the locking pin 70 through the track 30. When the locking pin 70 is located in the second lock position 35, the ring pliers can be in the internal position.

The pliers can be made from plastic, such as a high impact plastic, a metal, such as aluminum, steel or titanium, or a combination thereof.

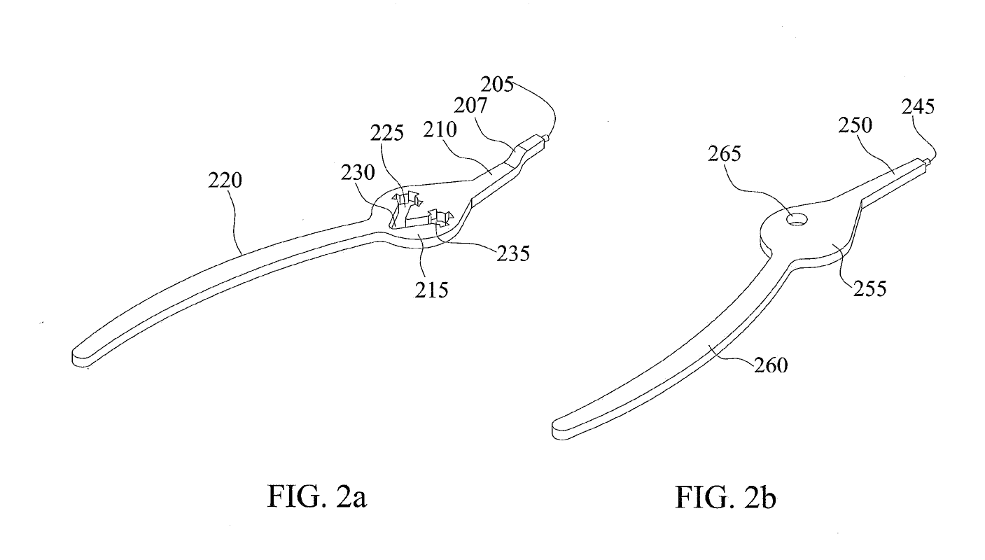

FIG. 2a. is a perspective drawing of lever 220 as it could appear from the bottom. Lever 220 can include a tip 205, a bend 207, an arm 210, a pivot region 215, a first lock position 225, a track 230 and a second lock position 235.

FIG. 2b is a perspective drawing of lever 260 as it could appear from the bottom. Lever 260 can include a tip 245, an arm 250, a pivot region 255 and an opening 265.

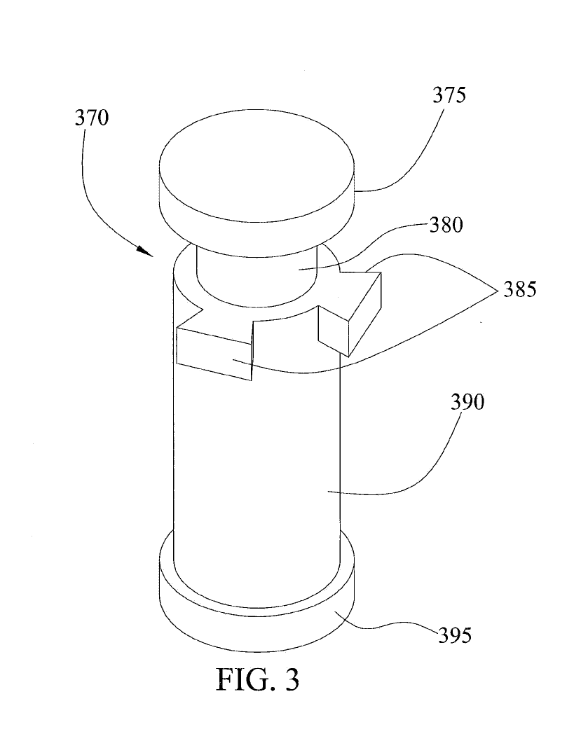

Referring to FIG. 3, the locking pin 370 can include a button 375, a sliding region 380, an at least one tenon 385, a catching region 390 and a base 395. The catching region 390 can pivotally connect the pivot region of the first lever and the pivot region of the second lever (not shown). More specifically, the catching region 390 can pass through the opening in the pivot region of the second lever to the first lock position or the second lock position in the pivot region of the first lever. The at least one tenon 385 can be positioned in the plane above the first lock position or second lock position to hold the locking pin 370 in place. A tenon can be a protrusion. The tenon can have a shape. A mortise can have a shape such that a tenon can pass through the mortise, for example, the tenon can fit exactly within the mortise. If there is more than one tenon and more than one mortise, the mortises can be spaced to match the spacing of the tenons. While maintaining the same spacing and shape, the mortises can be located at different positions around the first lock position and in the second lock position. The position can be based on the path of the first lever as it pivots in the internal and external positions. The button 375 and the sliding region 380 can extend out of the pivot regions.

In some embodiments, the locking pin 370 can also include a compression spring (not shown) wrapped around the sliding region 380. The compression spring can bias the button 375 and sliding region 380 away from the pivot regions of the first and second levers, thereby engaging the catching region 390. When the button 375 is pressed, the button can compress the spring, disengage the catching region 390 out of the pivot region of the first lever and engage the sliding region 380 into the pivot region of the first lever.

The at least one tenon and the base of the locking pin can pivotally hold the levers of the pliers together by biasing the first pivot region and the second pivot region towards each other. In order to move the locking pin from one lock position to the other lock position, the first lever can be rotated to align the at least one mortise in the lock position with the at least one tenon on the locking pin. The first pivot region can be moved away from the second pivot region which slides the at least one tenon through the at least one mortise such that the at least one tenon goes from a position in a plane above the first pivot region to a position in a plane below the first pivot region. The sliding region of the locking pin can enter the lock position in the first lever pivot region as the first lever is moved away from the second lever. The sliding region of the locking pin can then slide through the track to the other lock position. Once the locking pin is in the other lock position, the at least one tenon can be aligned with the at least one mortise in the other lock position. Then the first pivot region can be moved toward the second pivot region, which slides the at least one tenon through the at least one mortise such that the at least one tenon goes from a position in a plane below the first pivot region to a position in a plane above the first pivot region. The first lever can be rotated so that the at least one tenon and the at least one mortise are no longer aligned. This can allow the at least one tenon and the base to pivotally hold the levers of the pliers together again.

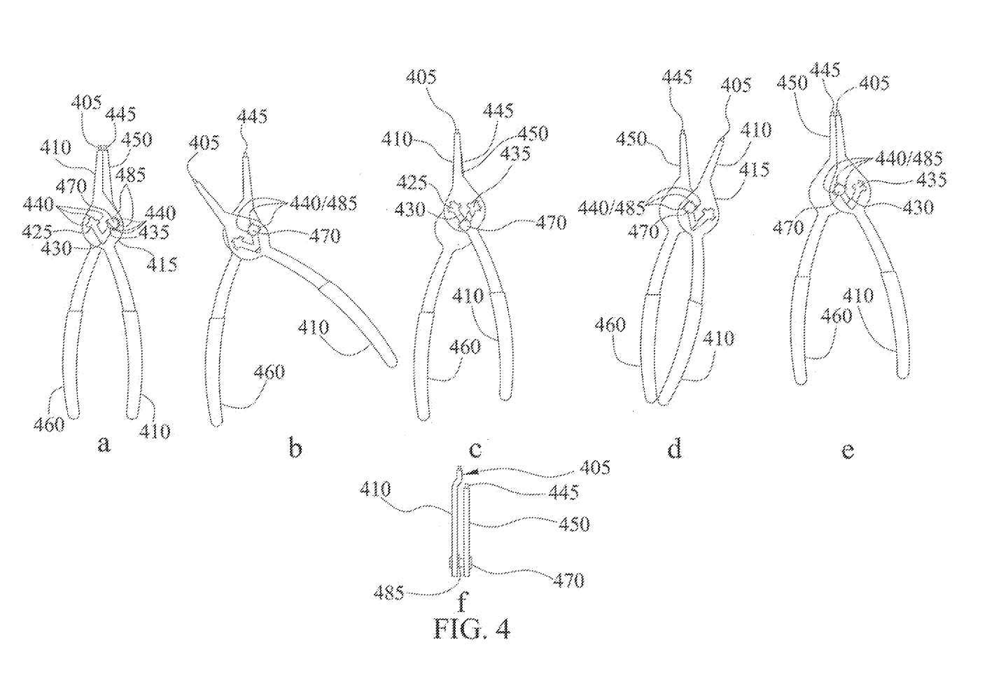

An example of changing the pliers from the internal position to the external position is illustrated in FIG. 4. The pliers can start in the internal position with the locking pin 470 in the second lock position 435 (FIG. 4a). In this position, the three tenons 485 and the base of the locking pin (not shown) can pivotally hold the levers of the pliers together by biasing the first pivot region 415 and the second pivot region 455 towards each other. The locking pin 470 can have three tenons 485 and the lock positions can have three mortises 440. To change the pliers from the internal position to the external position, the first lever 420 can be rotated to align the three mortises 440 in the second lock position 435 with the three tenons 485 on the locking pin 470 (FIG. 4b). The first pivot region 415 can be moved away from the second pivot region 455. This moves the first lever 420, which can include the first tip 405, the first arm 410, and the first pivot region 415, away from the second lever 460, which can include the second tip 445, the second arm 450 and the second pivot region 455. As the first pivot region 415 is moved away from the second pivot region 455, the three tenons 485 pass through the three mortises 440 such that the three tenons 485 go from a position in a plane above the first pivot region 415 to a position in a plane below the first pivot region 415. The sliding region of the locking pin 470 can enter the second lock position 435 in the first lever pivot region 415 as the first lever 420 is moved away from the second lever 460. The sliding region of the locking pin 470 can then slide through the track 430 to the first lock position 425 (FIG. 4c). Once the locking pin 470 is in the first lock position 425, the three tenons 485 can be aligned with the three mortises 440 in the first lock position 425 (FIG. 4d). Then the first pivot region 415 can be moved toward the second pivot region 455, which slides the three tenons 485 through the three mortises 440 such that the three tenons 485 goes from a position in a plane below the first pivot region 415 to a position in a plane above the first pivot region 415. This also moves the first lever 420, which can include the first tip 405, the first arm 410, and the first pivot region 415, away from the second lever 460, which can include the second tip 445, the second arm 450 and the second pivot region 455. The first lever 420 can be rotated so that the three tenons 485 and the three mortises are no longer aligned. With the locking pin 470 in the first lock position 425, the pliers can be in the external position (FIG. 4e).

Referring to FIG. 4f, a bend 407 can be introduced between arm 410 and tip 405 in order to position tip 405 in the same plane as tip 445. While transitioning the pliers from an internal position to the external position, or vice versa, the first pivot region 415 can be moved away from the second pivot region 455. The sliding region of the locking pin 470 can then enter a lock position in the first lever pivot region 415. The sliding region of the locking pin 470 can then slide through the track 430. As locking pin 470 is sliding through the track 430, the first pivot region 415, the first arm 410 and the first tip 405 are moving across the second pivot region 455, the second arm 450 and the second tip 445. To allow the first lever 410 to move across the second lever 460, the bend 407 in the first arm 410 can have a conformation that allows it to pass over arm 450 and tip 445. The tenons 485 can be below the plane of the first pivot region 415 as the locking pin 470 is sliding through the track 430. The tenons 485 can bias the first pivot region 415 away from the second pivot region 455, such that as the first lever 420 passes over the second lever 460, a minimum distance can be maintained between them.

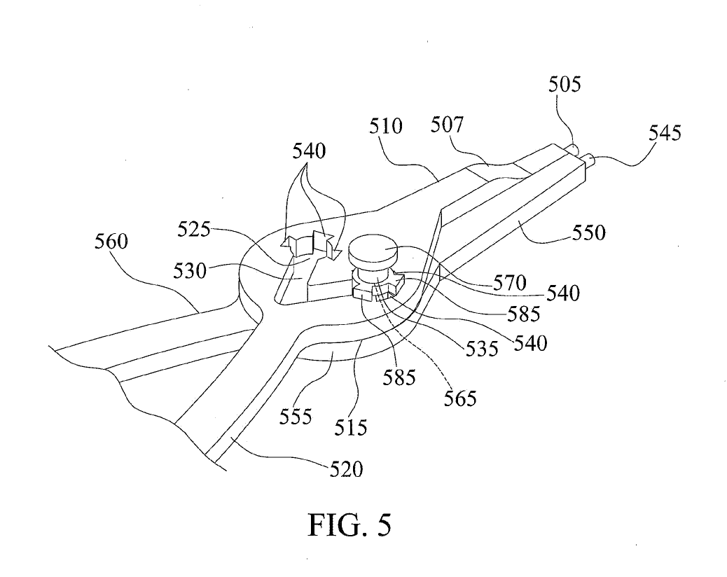

Referring to FIG. 5, the locking pin 570 can pivotally connect the pivot region of the first lever 515 and the pivot region of the second lever 555. More specifically, the locking pin can pass through the opening 565 in the pivot region of the second lever 555 to the first lock position 525, the track 530 or the second lock position 535 in the pivot region of the first lever 515. FIG. 5 shows the locking pin passing through opening 565 in the pivot region of the second lever 555 to the second lock position 535. In some embodiments, the locking pin has at least one tenon 585. For example, the locking pin can have one tenon, two tenons, three tenons, or more than three tenons. The at least one tenon 585 can slide through the corresponding at least one mortise 540 in the first lock position or the corresponding at least one mortise in the second lock position 540. When the at least one tenon 585 is in a position in the plane above the first lever, the at least one tenon 585 and the base can hold the locking pin 570 in place. The button and the sliding region can extend out of the pivot regions. In a particular embodiment, the locking pin has three tenons 585. The three tenons 585 can slide through the corresponding three mortises 540 in the first lock position or the corresponding three mortises in the second lock position 540.

FIG. 5 shows the pliers in the external position, in which the locking pin 570 can be in the second lock position 535. Additionally, FIG. 5 demonstrates the tips 505 and 545 extending collinearly with the arms 510, 550 of the levers 520, 560.

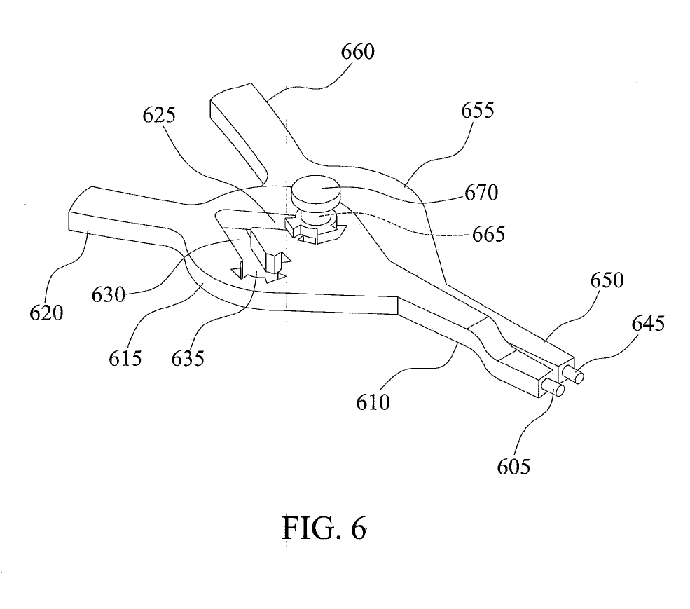

Referring to FIG. 6, the locking pin 670 can pivotally connect the pivot region of the first lever 615 and the pivot region of the second lever 655. More specifically, the locking pin 670 is shown passing through the opening 665 in the pivot region of the second lever 655 to the first lock position 625 in the pivot region of the first lever 615. FIG. 6 shows the pliers in the external position, in which the locking pin 670 can be in the second lock position 635. Additionally, FIG. 6 demonstrates the tips 605 and 645 extending collinearly with the arms 610, 650 of the levers 620, 660.

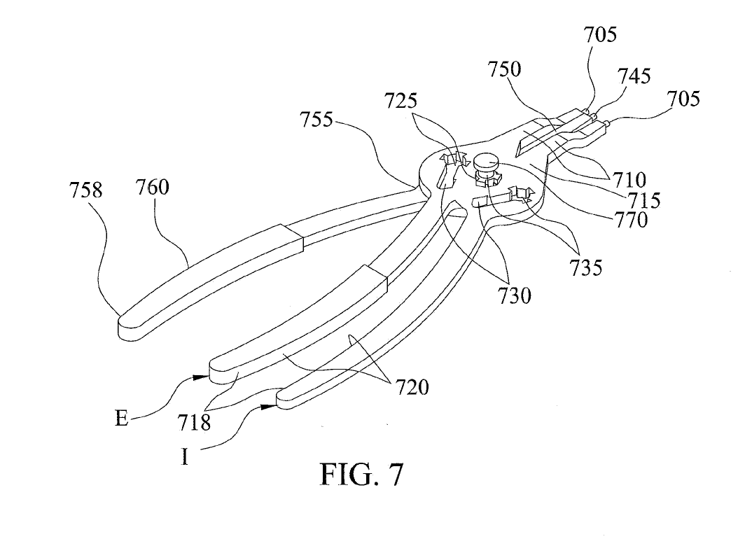

FIG. 7 illustrates the pliers in both the internal I and external E positions. While in the internal position, the locking pin 770 can be engaged in the first lock position 725. There can be a low amount of overlap of the pivot regions 715 and 755 when the pliers are in the internal position. Additionally, the first lever 720, including the handle 718, the pivot region 715, the arm 710 and the tip 705 can be positioned towards the same side of the second lever 760 when the pliers are in the internal position. In contrast, the locking pin 770 can be engaged in the second lock position 735 when the pliers are in the external position. There can be more overlap of the pivot regions 715 and 755 when the pliers are in the external position versus when the pliers are in the internal position. Furthermore, the handle 718 of the first lever 720 can be located on one side of the second lever 760, the pivot region 715 of the first lever can largely overlap with the pivot region 755 of the second lever, and the arm 750 and the tip 705 of the first lever can be positioned on the opposite side of the second lever 760 as the handle of the first lever 718.

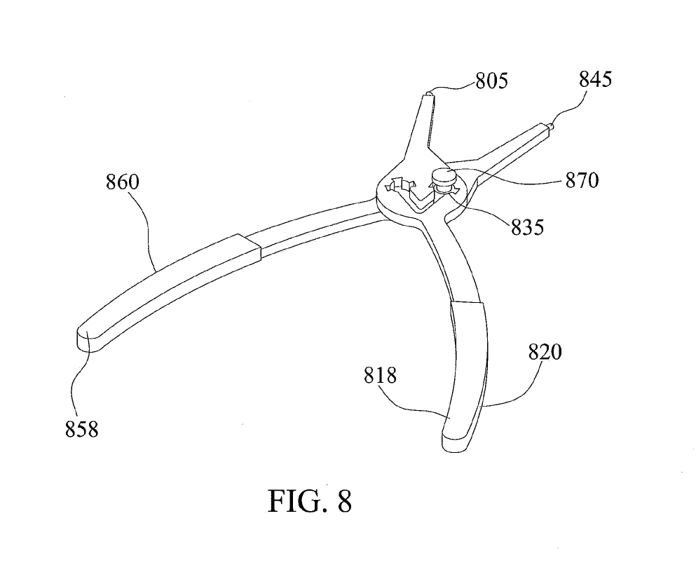

A tool for installing and removing external rings, for example, needs to expand the ring to increase its internal diameter. FIG. 8 shows the pliers in the external position, as the pliers could appear while expanding the ring. The locking pin 870 can be engaged in the second lock position 835. The tips 805, 845 can engage an external ring. The handle 818 of the first lever 820 can be pulled in the opposite direction of the handle 858 of the second lever 860, pivoting the two levers 820, 860 about the locking pin 870. As the handles 818, 858 are pulled away from each other, the tips 805, 845 can move away from each other (as shown in FIG. 8), thereby expanding the attached ring (not shown).

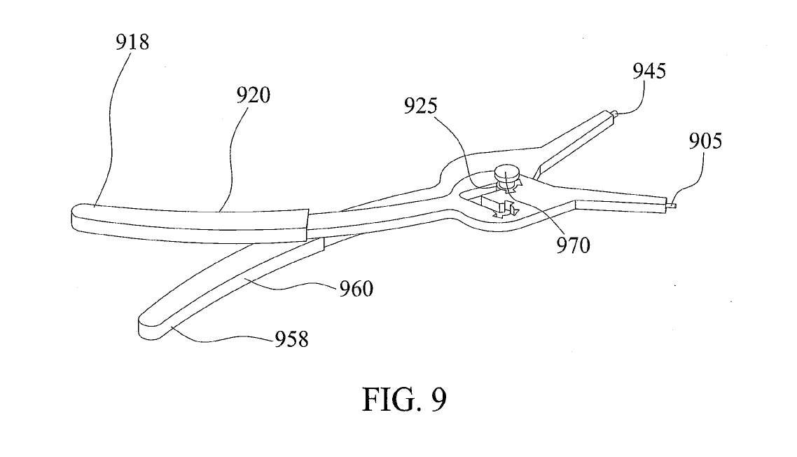

A tool for installing and removing internal rings, for example, must contract the ring to decrease its internal diameter. FIG. 9 shows the pliers in the internal position, as the pliers would appear while contracting the ring. The locking pin 970 can be engaged in the first lock position 925. The tips 905, 945 can be spread apart (as shown in FIG. 9) and can engage an internal ring. The handle 918 of the first lever 920 can be pulled towards the handle 958 of the second lever 960, past each other, and then away from each other. This can pivot the two levers 920, 960 about the locking pin 970. As the handles 918, 958 are moved, the tips 905, 945 can move towards each other, thereby contracting the attached ring (not shown).

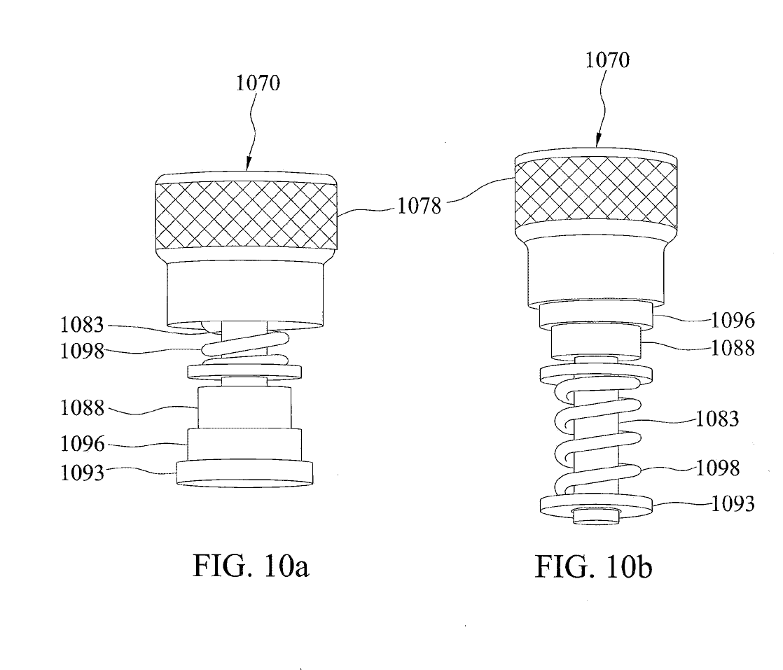

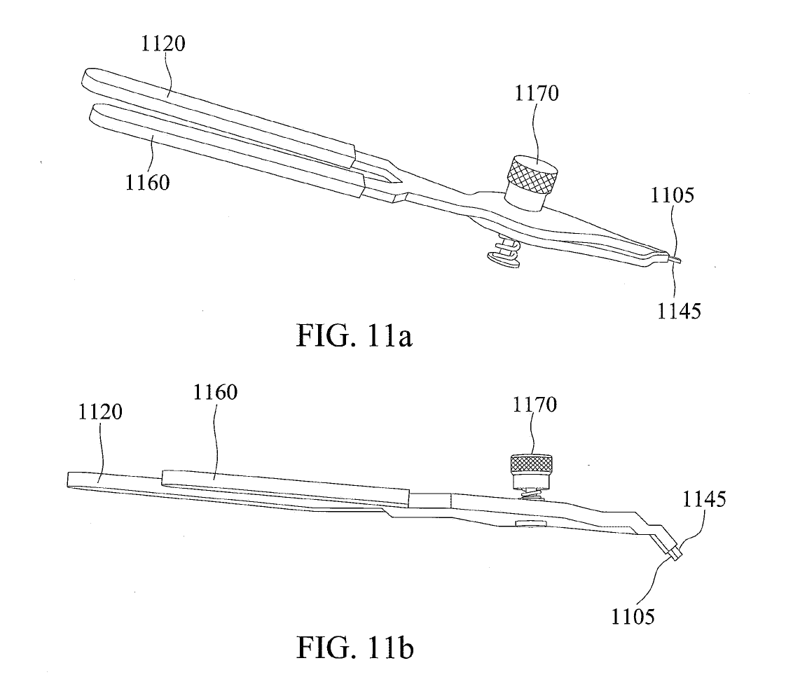

In addition to the configuration described above, the locking pin can be at least two other configurations. A second configuration of the locking pin 1070 is shown in FIG. 10a. The locking pin 1070 can be arranged with a button 1078 connected to the sliding region 1083. The sliding region 1083 can then be connected to the catching region 1088, and the catching region 1088 can be connected to the base 1093. A third configuration is illustrated in FIG. 10b. The locking pin 1070 can be arranged with the button 1078 connected to the catching region 1088, the catching region 1088 can then be connected to the sliding region 1083, and the sliding region 1083 can be connected to the base 1093. Both configurations are shown with a compression spring 1098. FIGS. 11a and 11b show the second and third locking pin configurations as part of the ring pliers, respectively.

The catching region 1088 further can include a threaded surface 1096. When using the first configuration, a corresponding threaded surface can be included in the opening in the pivot region of the second lever, allowing the threaded surfaces to engage. When using the second configuration, a corresponding threaded surface can be included in the lock positions in the pivot region of the first lever.

To move the locking pin 1070, the button 1078 can be turned to loosen the threaded surface 1096 from a corresponding threaded surface in the opening in the pivot region of the first or second lever, depending on the configuration. The button 1078 can then be pressed, which can disengage the catching region 1088. The sliding region 1083 can enter the lock position and can be slid along the track to the other lock position, where the catching region 1088 can be re-engaged. The button 1078 can be turned to engage the threading surface 1096. This process can switch the location of the levers in relation to one another and consequently, can change the pliers from the internal position to the external position, or vice versa.

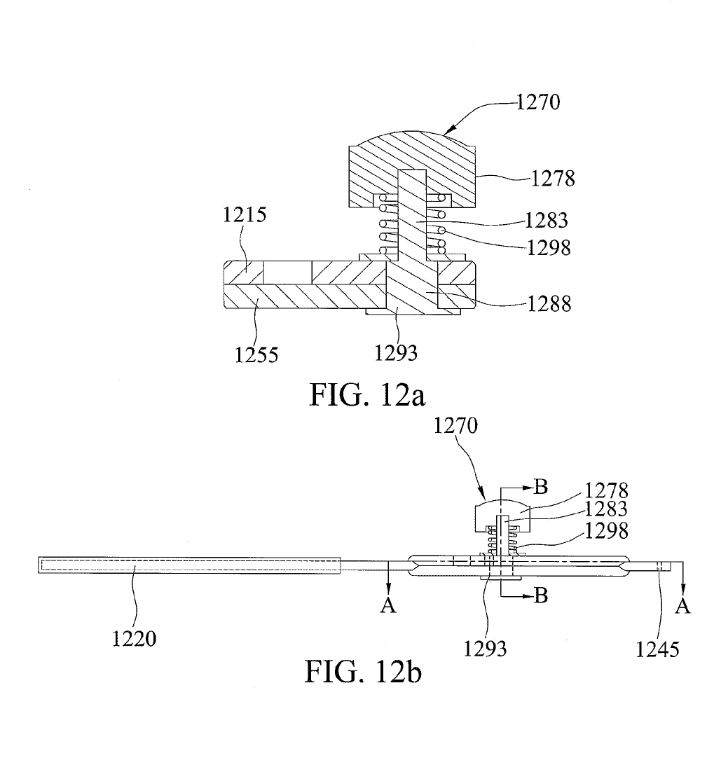

Referring to FIG. 12a, the locking pin 1270 can include a button 1278, a sliding region 1283, a catching region 1288 and a base 1293. The locking pin 1270 can optionally include a compression spring 1298, which can bias the button 1278 and sliding region 1283 away from the pivot regions of the first 1215 and second levers 1255, thereby engaging the catching region 1288. The catching region 1288 can pivotally connect the pivot region 1215 of the first lever and the pivot region 1255 of the second lever. More specifically, the catching region 1288 can pass through the opening in the pivot region 1255 of the second lever to the first position, track, or second lock position in the pivot region 1215 of the first lever. The button 1278 and the sliding region 1283 can extend out of the pivot regions.

FIG. 12b shows a right side view of the ring pliers. Viewed from this perspective, the locking pin 1270 projects up from the ring pliers. As shown, in the internal position, the first lever 1220 and the tip of the second lever 1245 appear closest in proximity. In the external position, the first lever 1260 and the tip of the first lever 1205 would appear closest in proximity. FIG. 12b further illustrates the tip 1245 extending collinearly with the arm of the second lever. It is also contemplated that the tips can be bent at angles, as shown in FIG. 11b.

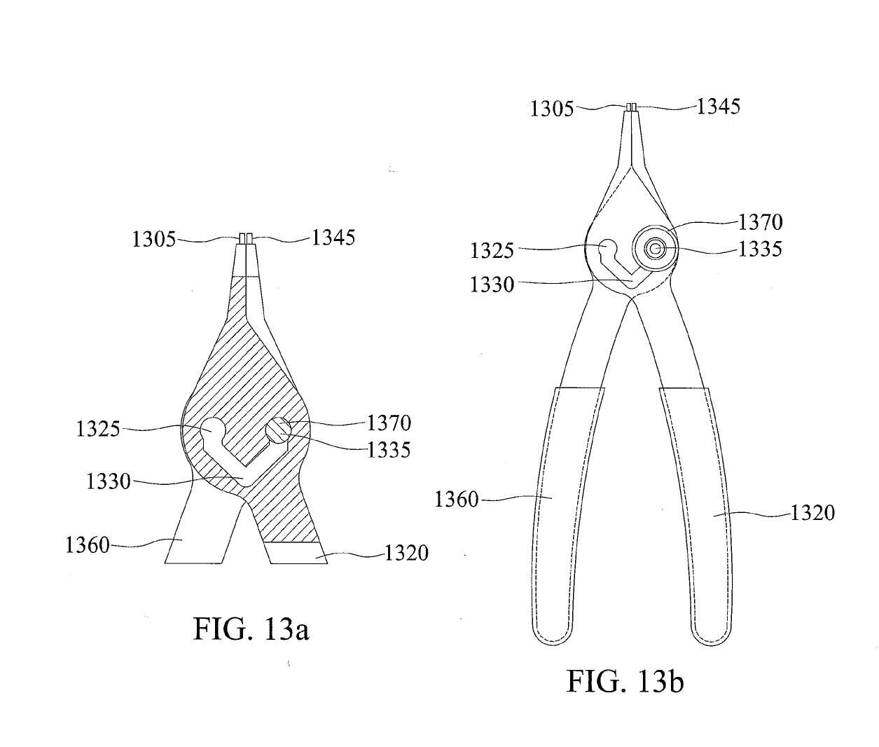

Referring to FIGS. 13a and 13b, the locking pin 1370 can pass through the opening in the pivot region of the second lever to the first lock position 1325, track 1330, or second lock position 1335 in the pivot region of the first lever. When the button is pressed, the catching region can be disengaged from the pivot regions. The sliding region can then be engaged and can traverse along the track 1330, allowing the locking pin 1370 to move back and forth between the first lock position 1325 and the second lock position 1335.

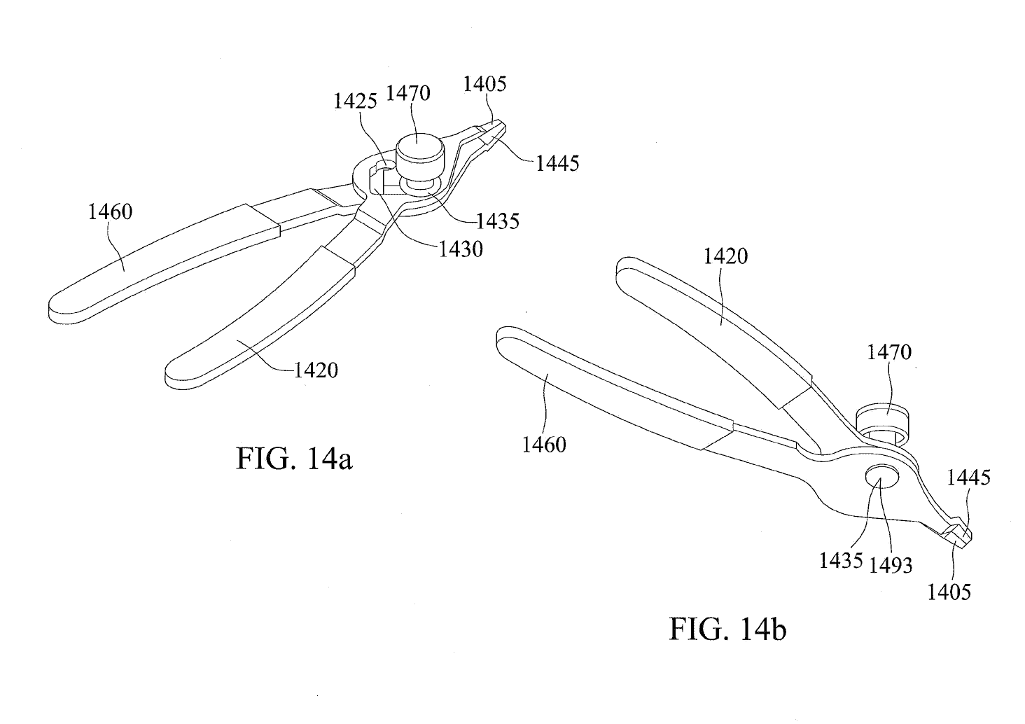

Furthermore, as illustrated in FIGS. 14a and 14b, the pliers can include additional features. The locking pin 1470 can include a compression spring configured to hold the catching region in the pivot regions when the button has not been depressed. Further features may include, but are not limited to, cushioned non-slip handles, precision machined tips and spring action handles.

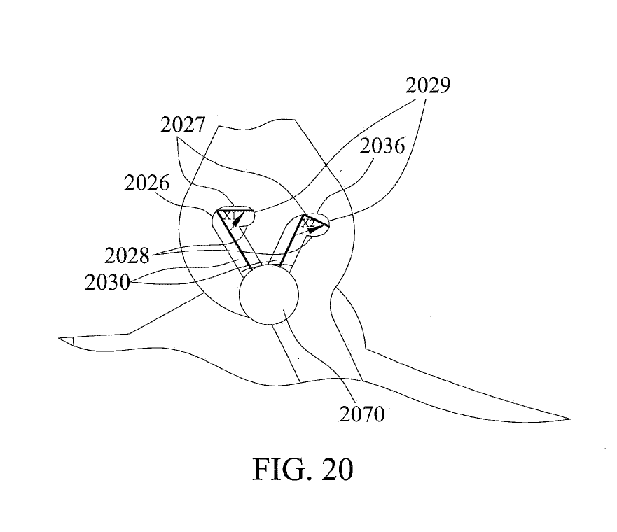

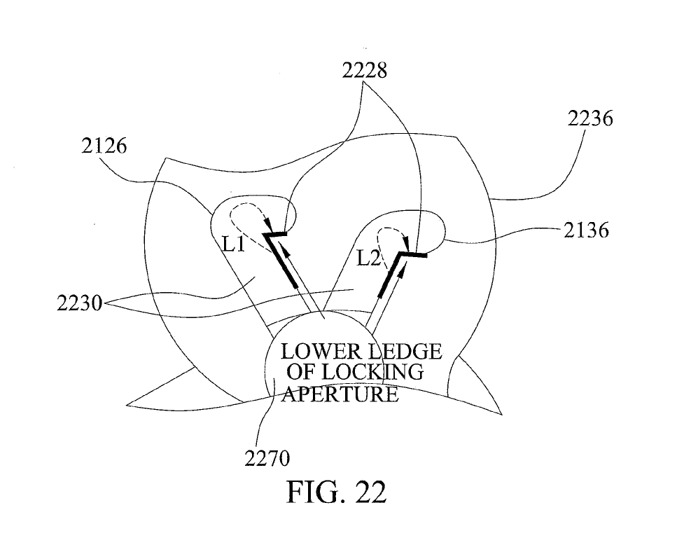

In another embodiment, the first position and the second position can be locking apertures 2026, 2036. FIG. 20 shows a close up view of the track 2030 and the locking apertures 2026, 2036. A locking aperture can be an extension of the track, which can be at an angle to the track. The aperture can include an upper ledge 2027 and a lower ledge 2028. The aperture can have an end 2029, which can be located at the point within the aperture that is farthest from the track. An angle of the aperture can be the angle as measured down the center of the track and aperture (see FIG. 20), an angle of the aperture can be the angle of the lower ledge of the aperture to the track (see FIG. 22), or both angles can be used to describe the aperture.

Referring to FIG. 20, X1 can represent the angle as measured down the center of the track 2030 and aperture 2026, 2036, which can be the angle a locking pin 2070 can traverse when moving up the track to the first lock position 2026. X2 can represent the angle that the locking pin can traverse when moving up the track to the second lock position 2036. As the angle of X1 or X2 decreases, it can become less likely that the locking pin will move back in the direction of the track 2030 towards the handle while in use. The angle of an aperture as measured down the center of the track and aperture can be greater than 0°, greater than 10°, greater than 20°, greater than 30°, greater than 40°, greater than 50°, greater than 60°, greater than 70°, or greater than 80°. The angle of an aperture as measured down the center of the track and aperture can be less than 90°, less than 80°, less than 70°, less than 60°, less than 50°, less than 40°, less than 30°, or less than 20°.

Similarly, referring to FIG. 22, as the angle of the lower ledge 2228 of the locking aperture 2226, 2236 to the track 2230 increases, it can become less likely that the locking pin 2270 will come out of the aperture and move down the transition channel towards the handle during usage. The angle of the lower ledge 2228 of the locking aperture to the track 2230 can be greater than 0°, greater than 10°, greater than 20°, greater than 30°, greater than 40°, greater than 50°, greater than 60°, greater than 70°, or greater than 80°. The angle of the lower ledge 2228 of the locking aperture 2230 to the track can be less than 90°, less than 80°, less than 70°, less than 60°, less than 50°, less than 40°, less than 30°, or less than 20°.

In addition to altering the angle of the lower ledge, the lower ledge of the locking aperture can be shaped in different ways including with a sharp edge, a rounded edge and even a somewhat “c” shaped ledge, with a curl in the upper portion of the “c”. As shown in FIG. 22, angle L1 can be greater than angle L2.

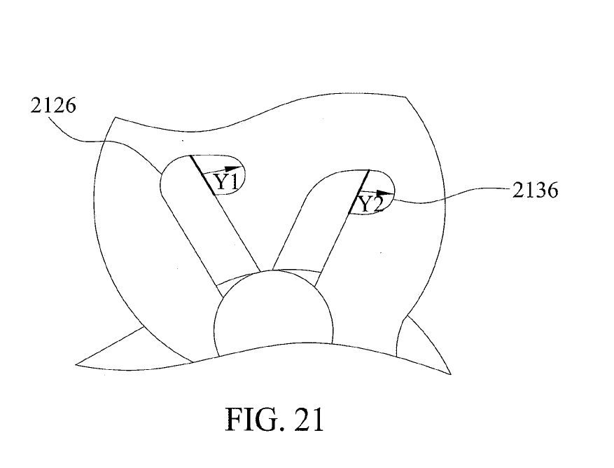

FIG. 21 shows a close up of the track and the locking apertures. Y1 and Y2 can be the distance from the track to the end of the aperture. As the distance from the track to the end of aperture increases, the locking pin can be more likely to stay in the locking apertures when the tool is in use. The distance can be greater than 0.1 inch, greater than 0.2 inch, greater than 0.3 inch, greater than 0.4 inch or greater than 0.5 inch. The distance can be less than 1.0 inch, less than 0.75 inch, less than 0.6 inch, less than 0.5 inch, less than 0.4 inch, less than 0.3 inch or less than 0.2 inch.

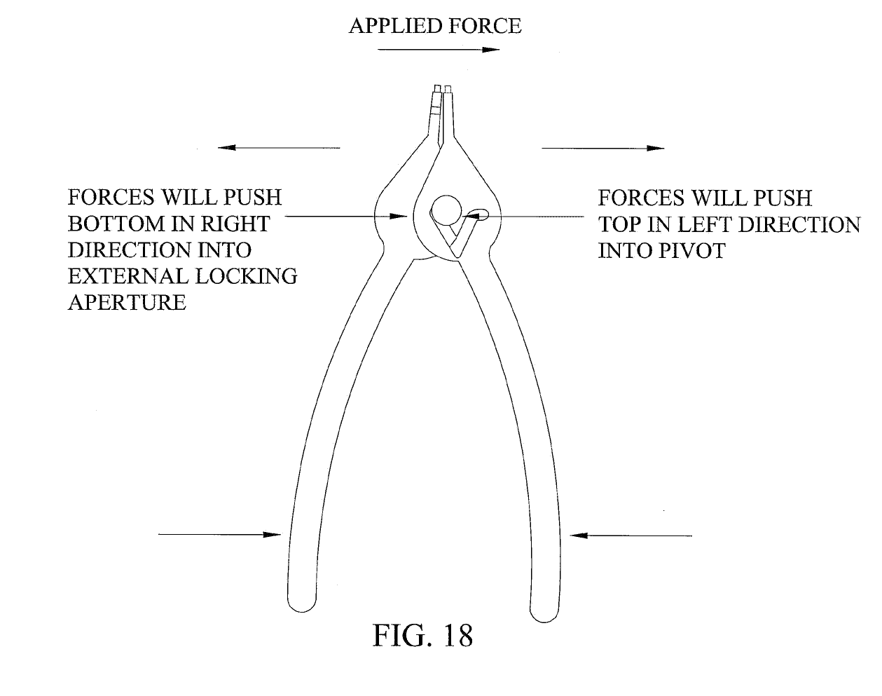

FIG. 18 shows the pliers in the external position. When the handles are pushed inward, the arms and tips can push outwards and spread open a snap ring. This action can create pressure on one lever to move it left and create pressure on the other lever to move it right. This can force the locking pin into the first lock position, which can be an external locking aperture, thereby locking the two levers of the pliers in place. This force can secure the locking pin in the first lock position. The levers cannot come apart during usage until the pressure can be relieved by completing the task of inserting or removing a snap ring. When the force is relieved, the locking pin can be moved from the lock position and move through the track. The locking pin cannot move down the track without manipulation because the locking aperture is offset from the track.

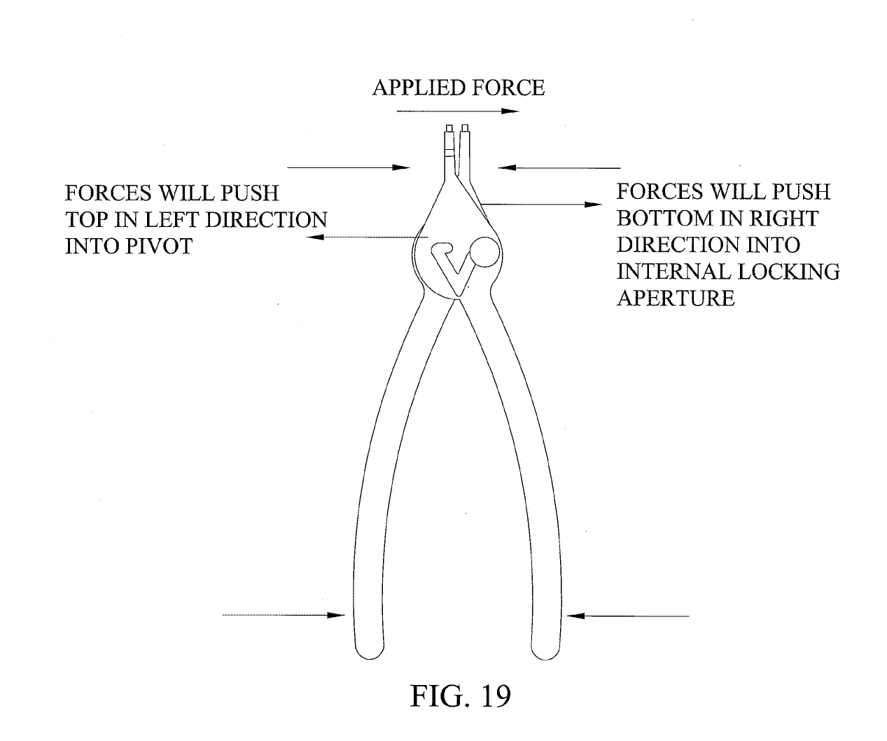

FIG. 19 shows the snap ring pliers in their internal position. When the handles are pushed inward, the arms and tips can push inwards and compress the snap ring arms together. This action can create pressure on one lever to move it left and create pressure on the other lever to move it right. This can force the locking pin into the second lock position, which can be an internal locking aperture, thereby locking the two levers in place. The levers cannot come apart during usage until the pressure is relieved by completing the task of inserting or removing a snap ring. The locking pin cannot move down the track because the internal locking aperture is offset from the track.

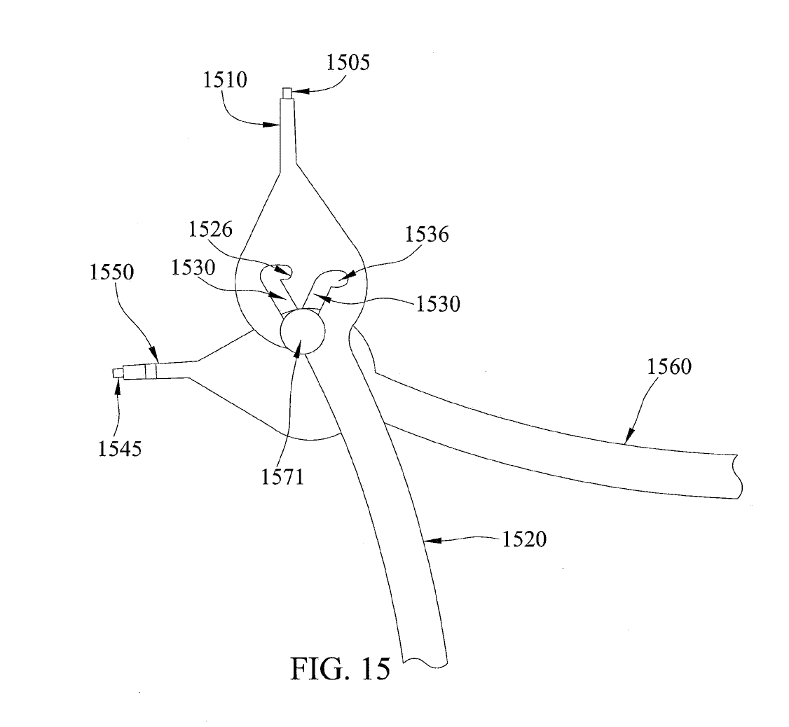

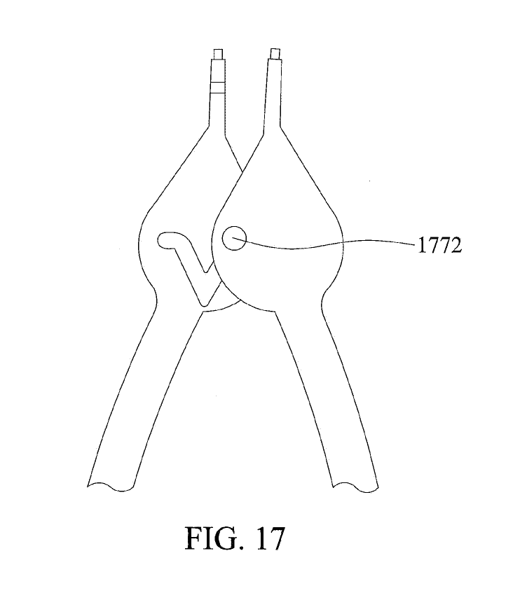

With an embodiment including locking apertures, the locking pin can include a top 1571 (see FIG. 15) and bottom 1772 (see FIG. 17), where the diameters of the top and the bottom are greater than the width of the track or the locking apertures. The locking pin can include a sliding region between the top and the bottom that enters the track and the locking apertures. The sliding region can be smooth. A washer and/or a spring may be placed around sliding region of the locking pin. The washer can increase the surface area for contact during transition from an internal to an external position. This can impart stability to the transition. The sliding region can have one or more diameters along its length. Other locking pins described herein can also be used with an embodiment including locking apertures.

Referring to FIG. 15, in multiple embodiments of the pliers, one lever can move slideably over the other lever. A locking pin can be attached to one of the levers at the pivot region (as shown in FIG. 17), pass through the pivot region of the other lever and held vertically in place by the top of the locking pin. The locking pin needs to be long enough in length to accommodate smooth movement of one lever over the other lever. Preferably the locking pin is not too long as to prevent “flexing” or “bowing” of one lever over the other lever when it is in use or under pressure.

FIG. 17 shows the bottom side of the snap ring pliers. The bottom of the pivot has been spun riveted.

In multiple embodiments of the pliers, one arm 1550 can be flat (FIG. 15). The other arm 1510 can be angled so that the tips 1505, 1510 of the arms align with each other when in the “closed” position, i.e., when the tips are touching or essentially touching each other in either an external or internal position. Tips can be fixed or removable. Tips may be flat, 45 degrees, 90 degrees or any other suitable angle.

In multiple embodiments of the pliers, a lever can have a track 1530 cut into it. The locking pin can be affixed to the lever that does not include a track (as shown in FIG. 17). The lever including the locking pin can be manipulated so that the locking pin moves through the track 1530 and then can be moved into a locking aperture 1526, 1536, either internal or external as this case calls for.

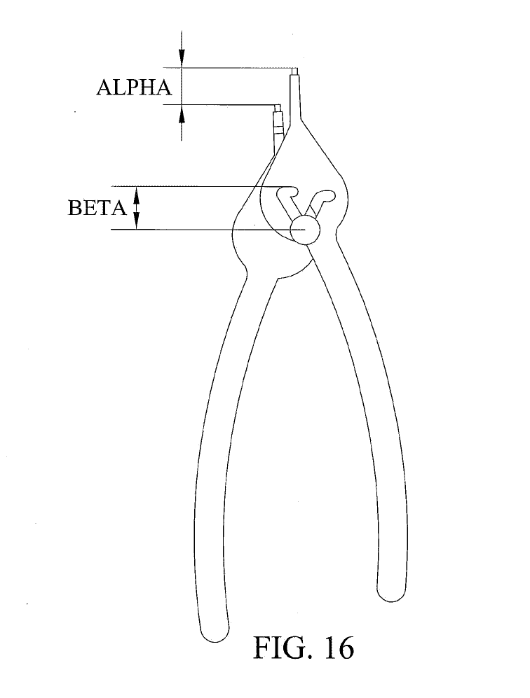

In multiple embodiments, the track 1530 may feature different shapes such as a “V” or a “U” of different angles but must permit the arm and tip of one lever to be able to pass rotationally under the angled arm of the other lever when adjusting from an internal to an external position. For this transition to occur, the track may need to be of a vertical distance in length to permit one lever to move down in the direction of the handles relative to the other lever. This can allow the tips 1545 of one lever to pass under the angled arm 1510 of the other lever. As such, the vertical distance of the track can, and may be required to, exceed the vertical distance that the tip of one lever must move under the arm of the other lever to then rotate beneath it from an external to an internal position and vice versa. This distance is illustrated in FIG. 16, where the distance Beta can exceed the distance Alpha.

The pliers can include interchangeable tips. The tips of the pliers can be straight or collinear with the arms of the pliers. The tips can also be bent at an angle, for example, between 0 and 90 degrees. More specifically, the tips can be bent 30 degrees, 45 degrees or 90 degrees. The interchangeable tips can mate seamlessly with the arms of the pliers. When an interchangeable tip is mated with an arm of the pliers, the attachment can be secure, withstand a reasonable drop test, and operate in a robust manner in a normal operating environment. The arm can be configured to be the female receptacle for a male attachment on the tips. Conversely, the arm can be configured to be the male attachment inserted into the female receptacle in the tips. The tips can be secured to the arms by either friction or by using a locking mechanism, rotating mechanism, twisting mechanism, a combination of these mechanisms or any other suitable securing mechanism. For example, a locking mechanism can be two threaded portions configured to be screwed together. Another example of a locking mechanism can be a spring, such as a spring loaded lock, pin or plunger. The locking mechanism can also be a screw or lock nut. The arms can be designed such that the tips are in the same plane as the arms, above the plane of the arms or below the plane of the arms.

A number of embodiments of the invention have been described. Nevertheless, it will be understood that various modifications may be made without departing from the spirit and scope of the invention. Accordingly, other embodiments are within the scope of the following claims.

1. A pliers comprising:
a first lever including a tip, an arm extending away from the tip, and a pivot region including a track, the track including a first lock position and a second lock position;
a second lever including a tip, an arm extending away from the tip, and a pivot region including an opening; and
a locking pin including a sliding region having a dimension for sliding the locking pin along the track from the first lock position to the second lock position.

2. The pliers of claim 1, wherein tip of the second lever is positioned adjacent to a first side of the tip of the first lever when the locking pin is in the first lock position, and the tip of the second lever is adjacent to a second side of the tip of the first lever when the locking pin is in the second lock position, and wherein the second side of the tip of the first lever is opposite the first side of the tip of the first lever.

3. The pliers of claim 1, wherein the tip of the first lever is configured to engage a ring and the tip of the second lever is configured to engage a ring.

4. The pliers of claim 1, wherein the locking pin further includes a catching region which pivotally attaches the pivot region of the first lever to the pivot region of the second region.

5. The pliers of claim 4, wherein the locking pin includes a button configured to move the catching region away from the pivot region of the first lever and the sliding region into the pivot region of the first lever when the button is pressed.

6. The pliers of claim 4, wherein each of the catching region and the sliding region include a first end and a second end opposite the first end, and the button is connected to the first end of the sliding region, the second end of the sliding region is connected to the first end of the catching region, and the second end of the catching region is connected to a base of the locking pin.

7. The pliers of claim 4, wherein each of the catching region and the sliding region include a first end and a second end opposite the first end, and the button is connected to the first end of the catching region, the second end of the catching region is connected to the first end of the sliding region, and the second end of the sliding region is connected to a base of the locking pin.

8. The pliers of claim 4, wherein the catching region is a wide pin element and the sliding region is a narrow pin element.

9. The pliers of claim 4, further comprising a compression spring biased to hold the catching region in the pivot region when the button is not depressed.

10. The pliers of claim 4, wherein the catching region includes a threaded surface that engages a complementary threaded surface of the pivot region of the first lever.

11. The pliers of claim 4, wherein the catching region includes an at least one tenon that engages an at least one mortise in the first or second lock position in the pivot region of the first lever.

12. The pliers of claim 4, wherein the first lock position and the second lock position are locking apertures.

13. The pliers of claim 1, wherein the tip of the first lever extends substantially collinearly with the arms of the lever.

14. The pliers of claim 1, wherein the tip of the second lever extends substantially collinearly with the arms of the lever.

15. The pliers of claim 1, wherein at least one arm includes a non-slip handle.

16. The pliers of claim 1, further comprises a compression spring between the first and second levers.

17. A method of adjusting a ring pliers comprising:
releasing a catching region of a locking pin from a first lock position in a pivot region of a first lever by sliding the locking pin through the pivot region of the first lever until a sliding region of the locking pin is engaged in the pivot region of the first lever;
moving the sliding region of the locking pin from the first lock position of the pivot region of the first lever to a second lock position of the pivot region of the first lever; and
securing the catching region of the locking pin in the second lock position.

18. A method of adjusting a ring pliers comprising:
removing a locking pin from a first locking aperture in a pivot region of a first lever;
sliding a locking pin through a track to a second locking aperture in a pivot region of a second lever; and
securing the locking pin in the second locking aperture.

19. A method of using a ring pliers comprising:
positioning a locking pin in either a first locking aperture or a second locking aperture of a pliers, wherein a pliers includes a first lever and a second lever;
the first lever including a tip configured to engage a ring, an arm extending away from the tip, and a pivot region including a track, the track including the first locking aperture and the second locking aperture;
the second lever including a tip configured to engage a ring, an arm extending away from the tip, and a pivot region including an opening;
the locking pin including a sliding region having a dimension for sliding the locking pin along the track from the first locking aperture to the second locking aperture;
engaging a ring with the tips of the first and second levers such that the ring applies a first force to the tips of the first and second levers;
applying a second force to the handles of the first and second levers,
wherein application of the first force and the second force are applied in the same direction and wherein application of the first force and the second force secure the locking pin in a locking aperture.
